(19) United States
(12) Patent Application Publication
(10) Pub. No.: US 2016/0203176 A1
(43) Pub. Date: Jul. 14, 2016

(54) UPDATING ROLLUP STREAMS IN RESPONSE TO TIME SERIES OF MEASUREMENT DATA

(71) Applicant: Michael Charles Mills, Maple Grove, MN (US)

(72) Inventor: Michael Charles Mills, Maple Grove, MN (US)

(21) Appl. No.: 15/073,854

(22) Filed: Mar. 18, 2016

Related U.S. Application Data
(63) Continuation of application No. 13/432,342, filed on Mar. 28, 2012.

(51) Int. Cl. G06F 17/30

(52) U.S. Cl. CPC G06F 17/30353; G06F 17/30516

(57) ABSTRACT

A time series of measurement data is received from a source device via a wide-area network. At least two streams of a data storage arrangement associated with the measurement data are determined. One of the streams is configured as a base stream having a time intervals corresponding to the time series of measurement data, and another is configured as a first rollup stream having time intervals each including a fixed plurality of the time intervals of the base stream. Both the base stream and the first rollup stream are updated in response to receiving at least a portion of the time series of measurement data.

### RELATED PATENT DOCUMENTS

This application is a continuation of patent application Ser. No. 13/432,342 filed on Mar. 28, 2012, to which priority is claimed and which is incorporated herein by reference in its entirety.

### BACKGROUND

The evolution of information technologies over the past decades has resulted in a significant increase in the amount of information that is freely available and instant accessible. Technologies that enhance access to this vast amount of data are in some ways just as vital as the information itself. An example of such technology is Internet search, which enables anyone with an Internet connection and browser to access to an ad-hoc, worldwide database of information using a few simple search terms.

The Internet serves as a repository for content that is largely human-created. Some data available on the Internet is also machine generated, such as databases that store weather measurements, stock prices, air traffic information, etc. While this data is often generated by authoritative entities (e.g., government weather and air traffic services, stock exchanges) machine-generated data may also be generated by individuals for their own use. For example, the availability of cheap microprocessors and reliable wireless networking has lead to what is sometimes referred to as “ubiquitous computing.” Ubiquitous computing generally refers to the proliferation of small inexpensive, portable devices. These portable devices have capabilities equal to that of desktop computers from years past, yet with orders of magnitude decrease in cost, power consumption, and size. The availability of ubiquitous computing devices may lead to an increase in the amount of machine-generated data by individual. This is analogous to trends such as social networking, which has lead to an increase in user-generated content on the Internet.

Example ubiquitous computing devices include smart phones and similar mobile computing devices. These devices, which are being adopted in ever-increasing numbers, enable instant access to the Internet, for both obtaining information and sending information out. Other examples of ubiquitous computing devices include devices that are not normally associated with computing, but have been extended with computer functionality. These types of devices may include home appliances, automobiles, utility monitoring fixtures, and human-implantable device, etc.

Some ubiquitous computing devices may fulfill legacy roles previously fulfilled by computers or telephones. For example, a mobile device may allow a user to compose an electronic message or document, in addition to placing telephone calls. Ubiquitous computing also enables large-scale automatically generated sensor data that is driven by the desires of individual users. Devices such as smart phones already include a wide range of sensors, such as microphones, cameras, thermometers, location sensors, etc., that can provide these services. Also, low cost microprocessor platforms such as Ardunio allow hobbyists to assemble hardware and software to create special purpose computing devices. It may be a natural extension of function of these devices to act as automatic data collectors.

Large numbers of ubiquitous devices storing, processing and sharing large amounts of information in near real-time is sometimes referred to as “Device Clouds” or “Internet of Things”. Systems, methods and apparatuses are described below that operate with these devices.

### SUMMARY

The present specification discloses systems, apparatuses, computer programs, data structures, and methods for updating rollup streams in response to time series of measurement data. In one embodiment, time series of measurement data is received from a source device via a wide-area network. At least two streams of a data storage arrangement associated with the measurement data are determined. One of the streams is configured as a base stream having a time intervals corresponding to the time series of measurement data, and another is configured as a first rollup stream having time intervals each including a fixed plurality of the time intervals of the base stream. Both the base stream and the first rollup stream are updated in response to receiving at least a portion of the time series of measurement data.

In one variation, the at least two streams may include a second rollup stream having time intervals that each include a fixed plurality of the time intervals of the first rollup stream. In such a case, the second rollup stream is updated in response to receiving the portion of the time series of measurement data, and the second rollup stream is updated based solely on corresponding values of the first rollup stream. Additionally in such a case, updating the first rollup stream may involve applying a first aggregator function to values of the measurement data and applying a result of the first aggregator function to the first rollup stream. In such a case, updating the second rollup stream may involve applying a second aggregator function to values of the first rollup stream and applying a result of the second aggregator function to the second rollup stream.

In another variation, updating the first rollup stream may involve applying an aggregator function to values of the measurement data and a result of the aggregator function is applied to the first rollup stream. In such a case, the aggregator function may include at least one of a sum, an average, a maximum, and a minimum. In any of these variations, the time series of measurement data may be received via a network application program interface of a distributed computing service.

In yet another variation, a user-defined function may exist between the aggregator function and the first rollup stream, such as for graphically representing the stream, triggering an event, etc. In such a case, updating the first rollup stream may further involve applying an additional rollup function to the values of the measurement data. A result of the additional rollup function may be maintained for benefit of subsequent rollup streams and not be used with the user-defined function, e.g., not displayed to the user. In some variations, the update to the base stream and the first rollup stream occurs in near-real-time.

Another embodiment involves defining a base stream and first and second rollup streams for storage of a time series of measurement data in a data storage arrangement. The base stream has time intervals corresponding to the time series of measurement data. The first rollup stream has time intervals each include a fixed plurality of the time intervals of the base stream, and the second rollup stream has time intervals that each include a fixed plurality of the time intervals of the first rollup stream. For each of the first and second rollup streams, a plurality of substreams is defined. Each substream corresponds to a different aggregator function. In response to receiving at least a portion of the time series of measurement data via a wide-area network, both the base stream and the substreams of the first and second rollup streams are updated in accordance with the respective aggregator functions. A user-defined function is performed based on a selected one of the substreams from each of the first and second rollup streams.

The above summary is not intended to describe each disclosed embodiment or every implementation of the invention. For a better understanding of variations and advantages, reference should be made to the drawings which form a further part hereof, and to accompanying descriptive matter, which illustrate and describe representative embodiments.

### BRIEF DESCRIPTION OF THE DRAWINGS

In the following diagrams, the same reference numbers may be used to identify similar/same components in multiple figures.

FIG. 1 is a block diagram of a system according to an example embodiment;

FIG. 2 is a block diagram of base and rollup stream intervals according to an example embodiment;

FIG. 3 is a class diagram of data objects according to an example embodiment;

FIG. 4 is a sequence diagram illustrating a use case according to an example embodiment;

FIG. 5 is a flowchart illustrating a stream rollup procedure according to an example embodiment;

FIGS. 6 and 7 are diagrams of user interface screens according to example embodiments;

FIGS. 8A-8C, 9A-9B, and 10A-10B are block diagrams illustrating rollup procedures according to example embodiment;

FIG. 11 is a block diagram illustrating how a rollup stream processes incoming data for the benefit of subsequent rollup streams; and

FIG. 12 is a block diagram of an apparatus according to an example embodiment.

### DETAILED DESCRIPTION

In the following description of various example embodiments, reference is made to the accompanying drawings that form a part hereof, and in which is shown by way of illustration various example embodiments. It is to be understood that other embodiments may be utilized, as structural and operational changes may be made without departing from the scope of the present invention.

The present disclosure is generally related to methods, systems and apparatuses that facilitate collection, consolidation, and communication of mass amounts of information that is independently generated by automated devices. In one aspect, time-indexed data is sent to a repository, such as a distributed computing service accessible via a common address. The data repository stores the data as streams, which includes collections of time series data, each collection being associated with at least one source device that generates the data (e.g., via sensor measurements). As the data arrives, each element of the data is assigned to at least one stream based on a granularity of the time, and may be assigned to multiple streams of different time granularity in a single transaction. In this way, various views/aspects of the data are each processed together in real-time or near-real-time, and through the use of distributed computing and mass storage, this data-processing can be scalable to an unprecedented extent, e.g., to millions of contemporaneous transactions, at a granularity of one measurement per second or finer.

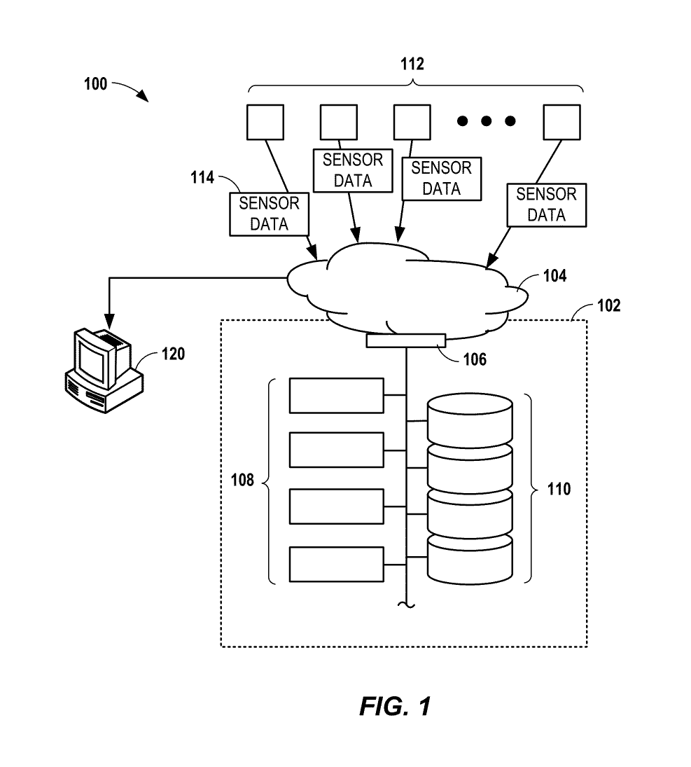

In reference now to FIG. 1, a block diagram shows a system 100 according to an example embodiment. The system 100 includes a “cloud” service 102 that may include at least network facilities 106 for communicating via a wide area network 104 (e.g., the Internet) and computing facilities 108, 110 for providing respective processing and data storage functions on behalf of the service 102. The service 102 may be massively paralleled, which generally involves connecting computers (e.g., via a fast local network) to work together in a loose conglomeration so that in some respects they can be viewed as a single computing system. This parallelism may extend to common or separate parallel infrastructures for both the processing facilities 108 and data storage facilities 110. For example, parallel processing may involve dividing, distributing, and collecting the results of a processing task to different processing units 108. Similarly, a distributed database may distribute and replicate data across a large number of storage units 110 for fast data storage and retrieval.

One function of the illustrated system 100 involves collecting data from a plurality of source devices 112. The source devices 112 gather data (e.g., sensor data 114) and repeatedly send the data 114 to the service 102. The data 114 may be sent directly to the service 102, or indirectly via proxies, aggregation nodes, etc. (not shown). Generally, the wide area network 104 facilitates these transfers by providing baseline communication environment that enables finding network endpoints and facilitating data transfer therebetween. As previously mentioned, this network 104 may include the Internet, as well as other data transfer infrastructure, such as mobile data networks, private networks, point-to-point links, etc.

The source devices 112 and data 114 generated by the devices 112 may each be associated with at least one account. Multiple source devices 112 may be associated with a single account, and a single device 112 may be associated with multiple accounts. As will be described in greater detail, association of the data with accounts can assist in defining how and where data is stored, protect privacy, enable combinations of data from different sensors, allow custom tailored data collection and storage profiles, manage billing/payments (if any), etc.

The data 114 may include a discrete measurement value (e.g., one or more bytes representing a data structure such as a number, a Boolean, a date-time, an image, video, string, etc.) accompanied by a time stamp, generally referred to herein as date-time stamp. The data 114 can be uploaded via network facility/interface 106 using a Representational State Transfer (REST) protocol, such as Hypertext Transfer Protocol (HTTP) operating over Transmission Control Protocol/Internet Protocol (TCP/IP). The network facility/interface 106 may also be adapted to receive data using other protocols, such as Universal Datagram Protocol (UDP) streams, multicasting, high-level messaging protocols (e.g., short message service, email), etc.

The source devices 112 can collectively generate large amounts of data when configured for small sample times. For example, a value that is recorded every second can result in 31,536,000 data points for a year. Although this small resolution of data allows for real-time monitoring of devices and historical value, this fine level of detail may not be used by some end uses or business decision processes. For example, an electricity meter might record usage every minute but the customer may be billed based on monthly usage. In another example, a temperature probe might record a value every minute but the end-user may only want to set alerts on the maximum temperature of a weekday. Even so, the receiving and recording of the fine-grained measurements may be necessary to ensure the coarser grained measurements are accurate. However, long term storage of the fine-grained data may be optional in some scenarios.

The system 100 provides a real-time mechanism for aggregating device generated data into user defined cycles. For purposes of the current discussion, the term “stream” is used to describe a time series of data that may either be received from source devices 112 or created from other streams. A “base stream” is formed based on a repeated transmittal of data 114 to the service 102 from a source device 112. This data may be repeatedly transmitted at intervals that may or may not be regular. For example, the data may be usually sent at regular intervals but may have gaps, e.g., data that is missing for a pre-defined time intervals. Or the data may be of such a nature that regular intervals are not needed or possible, e.g., data that is captured in response to random events, such as a motion sensor. The existence and quantity of time-interval gaps in such data may still be of interest, e.g., to gauge amount of traffic passing by the sensor.

The use of the term “stream” is not meant to require that the protocols used to transmit or process the data are streaming. For example streaming protocols such as Real-Time Transport Protocol, are often associated with sending multimedia data such as sound and video over a network. While the system 100 may be configured to utilize streaming protocols, other discrete data transfer protocols may also be used. For example, a device 112 reporting data every minute may establish and release a TCP/IP socket for each data report, e.g., where the report is communicated to the service 102 via an HTTP POST or GET. For shorter reporting cycles, it may be more efficient to keep a TCP/IP socket established indefinitely, but still report the data through discrete HTTP transactions. Data reporting transactions may be combined, e.g., a single transaction may include n-sequential measurements running from time t₁ to tₙ, A single transaction may also contain data with same or different time stamps but that originate from different streams of a component, and so would be used to update different base streams.

Another term used herein is “rollup,” which generally refers to a stream created from one or more other streams. The rollup stream generally has a coarser time granularity than the stream(s) being used to form the rollup stream. For example, a one-measurement-per-second stream may be rolled up to a stream having with granularity of minutes, hours, days, etc. The aggregation may include application of any statistical, logical, or mathematical operation known in the art, including a sum, average, median, mean, mode, maximum, minimum, etc. Neither the base stream nor rollup stream need be “regular,” e.g., elements of the stream do not need to have the same time widths. For example, a month interval can vary between 28-31 days. However, it may be preferable that the rules for applying a rollup are well-defined, e.g., it is possible to determine the appropriate rollup interval to which any given base measurement belongs. For example, days can be rolled up evenly into months, as each month has a well-defined, integer number of days. In contrast, calendar weeks may not be rolled up evenly into months, because a week can span two different months.

The system 100 includes an Application Program Interface (API) that facilitates both the addition of data 114 via source devices 112 and the retrieval of data via a user device, such as computer 120. The API can facilitate viewing of the data 114 on software such as a browser running on the computer 120. As with adding data 114, data statistics and rollups can retrieved via REST protocols for presentation to the user as known in the art. Rollups can be used to present useful summary information that is highly customizable and that can be monitored near-real-time. For purposes of the present discussion, “near-real-time” is intended to indicate that updates to the base and rollup data occur in response to the same data reception event, e.g., receipt of a data message via the network. This can be contrasted from arrangements that utilize other events, such as timers, user input, system utilization, etc., to calculate at least the rollup values.

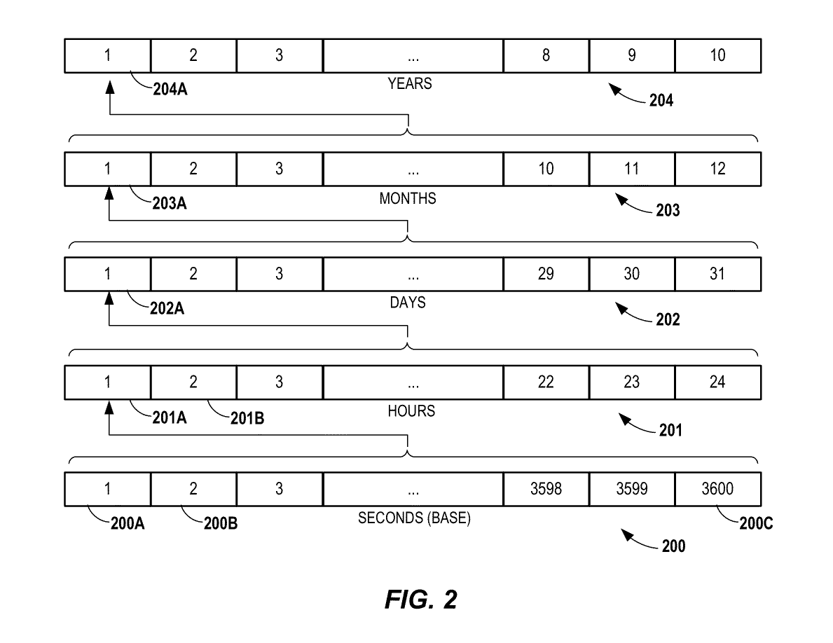

An example of rollup intervals is shown in the block diagram of FIG. 2. Generally, each row 200-204 represents a different stream that is independently updateable. Each stream is associated with at least one base stream 200, which receives a time series of measurement data from a source device via a network. The base stream 200 stores discrete measurements each associated with a different one-second interval, represented here by example measurements 200A and 200B. The other streams 201-204 are rollup streams that are modified in response to each change to the base stream 200.

For example, when measurement data is received (e.g., via a network transaction with a remote sensor device), the measurement data is added to a storage location 200A for stream 200 based on a timestamp included with the data and the time interval associated with the storage location 200A. The measurement data is also applied to storage locations 201A-204A, which are time periods within respective streams 201-204 that correspond to 200A. As described above, “application” of data to a stream may involve any type of operation or function (e.g., sum, average, minimum, maximum, etc.) that is applied to aggregate data within an element of the respective streams. Other functions might be applied to the data before it is aggregated, and may be considered part of applying the data to a stream. For example, applying floor/ceiling functions, time filters, gap filling, may be applied to data of a base stream that modifies or removes data, but may still result in a change to the rollup streams, e.g., compared to a scenario where such other functions are not used.

Differing streams 201-204 may have different aggregation operations applied during the update. For example, if each element of stream 201 includes a sum for a known number of seconds, then each element stream 202 may also include a sum, and an average. The user may associate these aggregation functions with a user-defined function that satisfies some desire of the end user. User-defined functions may include displaying an average over some time interval, triggering alerts based on min/max values over the same or different time intervals, etc. Regardless of the rollup function the user has associated with a rollup stream, rollup streams may maintain a base set of aggregation values to ensure data is not lost during rollup to subsequent rollup streams. In the illustrated layout, for example, assume stream 201 uses a minimum rollup function, and stream 202 uses an average rollup function. It would be presumed that the values in streams 202 are averages of the base stream 200 within a given time interval, and not averages of the minimum values of the adjacent stream 202 within the same interval. Therefore, stream 201 would also aggregate values such as sum, non-gap time intervals, etc. Even if such aggregation data is not necessary to determine minimum values of time intervals of stream 201, it may be needed by higher level rollup streams, and also allows the user to later select a different rollup function of stream 201 for display, export, alerts, etc. and see the result immediately without the system having to recalculate from the base stream 200.

Each of the streams 200-204 is illustrated with an endpoint that indicates an increment of the next higher stream. Using stream 200 again as an example, elements within the range starting at 200A and ending at 200C will be input to element 201A. Data of stream 200 subsequent to element 200C will be input to element 201B, etc. It should be noted that this system may allow gaps to occur, e.g., element 201A may not require 3,600 consecutive values from stream 200 to be input to element 201A before element 201B is selected. The relationship may be defined as “is contained in.” For example, data with time stamps 12:00:04 AM and 12:59:57 AM in stream 200 are contained in element 201A, which has time stamp 12 AM (e.g., includes interval 12:00:00 AM to 12:59:59 AM).

The rollup can occur in all streams in response to the same transaction as the one in which data was uploaded. This provides consistency across all rolled-up streams and allows for near real time viewing of rolled up streams. For example, elements 200A-204A may all be updated together as part of the same transaction. This allows rolled-up streams 201-204 to be treated the same as base stream 200. A rolled-up stream can be viewed in a live dashboard graph, have alerts set on it, be used in derived stream calculations, etc. Generally, a rollup stream can be used for the same purposes as a base cycle stream 201-204.

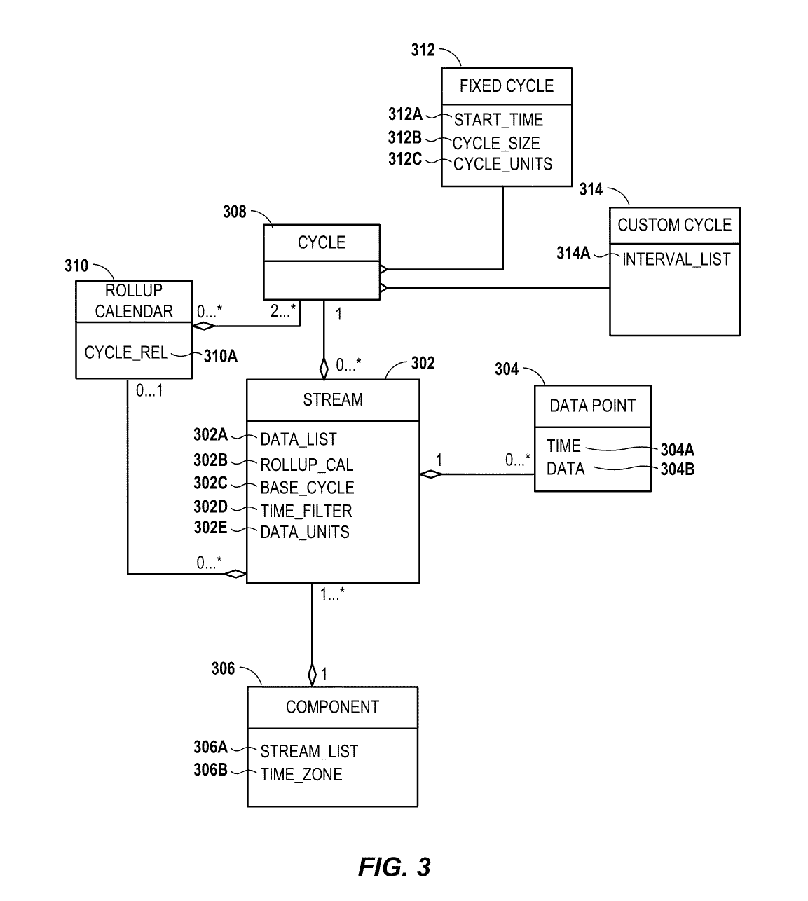

In reference now to FIG. 3, a Unified Modeling Language (UML) class diagram is used to illustrate objects involved in the stream roll-up process. Components, streams, and the likes are software concepts that may be implemented as objects in an object oriented programming language and/or reflected in database structures for persistent storage. This figure illustrates example class definitions for streams 302, components 306, cycles 308, and rollup-calendars 310. Each of the classes may include methods and/or data that describes their characteristics and defines how the system processes, store and present the data. The methods that can be invoked on instantiated objects in an object oriented programming language.

As previously noted, a stream 302 represents a collection (e.g., list 302A) of time series data. Here the data values stored in the list 302A are represented as a class 304 that includes at least two members, a timestamp 304A and data 304B. The timestamp 304A may include both a start time and an end time. The data 304B can be numbers, dates/times, text, booleans (yes, no), geolocation (latitude, longitude), etc. Each stream 302 can have its own rollup calendar 302B, cycle 302C (e.g., that defines sample size, intervals), time filter 302D and data unit 302E. Data 302A of the stream 302 can be uploaded via the network and/or a stream 302 can be defined as a derived stream.

In this example, a stream object 302 is used to access both a base stream and rollup streams associated with a source device, which is abstracted as a component object 306. Data 304 that originates from the source device is uploaded to the base cycle 302C of stream 302. The rollup calendar 302B also defines all rollup streams, which are updated in response to the same data event that causes updates to the base stream. Any non-base cycle information of a stream can be used (graphing and such) just like the base cycle.

A component 306 is an abstract concept that represents physical devices or nonphysical devices. Component 306 may represent physical devices such as utility meters, smart plugs, sensors (temperature, accelerometer, etc.), cellular phones, vehicles, etc. Component 306 may also represent non-physical devices such as computer programs that: track computer memory and CPU usage in a server farm; poll a relational database for information; upload real-time financial information such as sales figures, expenses, stock quotes; etc.

A component 306 may be considered a container for a group of streams 306A that share similar characteristics, such as a location. For example, a component 306 might represent a sensor that monitors temperature and humidity. Temperature could be one stream and humidity could be another stream. If the sensor were mobile, its component 306 could also have latitude and longitude streams that record the location of the sensor component over time.

A cycle 308 is used to represent a user defined recurring period. For example, the stream's interval sizes (sample size) are specified by the base cycle 302C associated with the stream 302. A cycle 308 can be defined to be fixed 312 or custom 314. For a fixed size 312, the user defines the reference date-time 312A, which may include a time zone. If a time zone is not included in the data, then the component's time zone can be used. The reference date-time and time zone are used to calculate each interval's start and end date-time for all intervals occurring prior to the reference date and after the reference date. The user can also define a cycle size 312B and units 312C. This allows, for example, the user to define the cycle as having “X” number of seconds, minutes, hours, days, weeks, months, or years. An example instantiation of a fixed cycle 312 may include “Second,” where size 312C is one, units 312D is seconds, and reference time 312A is Dec. 31, 2011 12:00:00 am. Another example of a fixed cycle is “Quarterly,” where size 312C is three, units 312D is months, and start time 312A is Jan. 15, 2012 12:00:00 pm.

The custom cycle 314 may include a collection (e.g., list 314A) of time intervals. This list 314A defines a collection of start and end date-times for each interval and a time zone. An example of a custom cycle user-defined seasons of Spring, Summer, Fall, Winter. In this and the other cycle classes 308, 312, 314, time zones are used for the start date-time for fixed cycles 312 and for the start and end date-times for custom cycles 314. The time zone can be set to use a time zone 306B of the component 306 time zone so that the same cycle can be used across time zones.

The rollup calendar 308 is an optional component that defines how stream intervals can be rolled-up for viewing and analysis. If a stream 302 has a base cycle 302C set for one second intervals it quickly becomes cumbersome to view and analyze a years worth of data which is 31,536,000 intervals. For example, a year's worth of 4-byte “float” data would be about 120 Megabytes. Instead of downloading 31 million intervals and sifting through them, a user is better off downloading a set of rolled-up stream data at a larger interval size and then drilling in on the interesting cycles.

In another scenario, a user may want to monitor energy usage in one-second intervals so as to watch for certain events, but may be billed based on monthly kW and or kWh. This may be done by associating a rollup calendar 310 with a one-second stream 302. The stream 302 has one-second intervals and a second stream 302 with monthly intervals can be automatically formed with the rollup logic while the first stream's one-second interval data is being uploaded. Both of them would use the same units, e.g., kWh. The second stream 302 sums the one-second data of the first stream received within a respective one-month interval that the data belongs. In this way, the user can view/monitor one-second intervals, in near real-time, and can also view/monitor the one month cycle intervals at the same time. This may allow the user to watch the one-month cycle interval change with the same update frequency as the one-second stream.

The rollup calendar 310 is referenced by zero or more streams 302 and used to update rollup streams. It should be noted that a rollup stream 302 would not necessary have a rollup calendar 310, in which case the member object 302B could be set to null. Or in the alternate, a different stream class (not shown) can be used to represent rollup streams. This rollup stream class and the illustrated stream class 302 may inherit a common interface so as to enable the system to utilize common stream methods and behaviors regardless of the underlying specific type of stream.

The rollup calendar 310 may have a component 310A that facilitates determining relationship between the streams 310A, e.g., how the cycle 308 of one stream 302 is defined/used to fill the cycle 308 of another stream 302 (e.g., 60 one-second intervals go into one minute). The stream and/or cycle classes 302, 308 may have methods that allow these relationships to be derived, and in such a case, member variable 310A may not be strictly needed. However, it may be useful to persistently store a representation of these relationships to reduced computation overhead. For example, when a rollup calendar 310 is saved it will be sorted and validated. In such a case, a relationship that tries to rollup a one-week interval stream into one month stream may fail because week boundaries do not always fall on month boundaries, e.g., a week can belong in two different months at the same time. The stream cycles may also be validated to ensure they contain no gaps. For example, a custom cycle 314 defining seasons should ensure all days of the year (which includes leap years) are mapped to one season.

Referring back to FIG. 2, streams 200-204 each have respective cycles associated, e.g., per-second, per-hour, etc. This may be used to define a rollup calendar as described above. After the rollup calendar is defined and associated with a stream, the stream's data for each rolled-up cycle is available in real-time. In some arrangements, uploaded data may be consolidated to make more efficient use of network resources. So stream 200 may actually record data in one-second intervals, but the data may be uploaded to the service every 10 seconds. When the stream uploads 10 intervals of data (one second each), all the rollup data is immediately available via the API and browser user interface.

As previously mentioned, an API is used to submit data and request data. In Table 1 below, functions are listed for requesting data from a rollup cycle. Gap intervals are ignored for some of the functions in Table 1 (First, Last, Min, Max, Avg, Min Occurrence, Max Occurrence).

| Function | Description |
|---|---|
| First | Returns the first interval value of the |
| | underlying cycle |
| Last | Returns the last interval value of the |
| | underlying cycle |
| Min | Returns the smallest interval value of the |
| | underlying cycle |
| Max | Returns the largest interval value of the |
| | underlying cycle |
| Avg | Returns the time weighted average the |
| | underlying cycle |
| Sum | Returns the sum of the intervals of the |
| | underlying cycle |
| MinOccurance | Returns the start date-time the minimum |
| | occurred for the base cycle, accurate to the |
| | second |
| MaxOccurance | Returns the start date-time the maximum |
| | occurred for the base cycle, accurate to the |
| | second |
| GapCount | Returns the number of base cycle interval |
| | gaps that occurred for this cycle's range. For |
| | example, if the base cycle is 1 Second, the |
| | requested rollup cycle is 1 Year, and the |
| | request date-time range is Jan. 1, 2010 12:00 |
| | am to Jan. 1, 2011 12:00 am then a single |
| | value representing how many 1 second |
| | intervals are Gaps is returned. |
| NonGapCount | Like GapCount but returns the number of |
| | base cycle intervals that are not gaps for the |
| | requested date-time range. |
| IntvlCount | Returns the number of base cycle intervals |
| | whether they are a gap or not |
| MillisecCount | Returns the number of milliseconds for the |
| | requested date-time range |
| NonGapMillisecCount | Returns the number of nonGap milliseconds |
| | for the requested date-time range |

Note that a stream's base cycle does not have to exist within a rollup calendar it is referencing. It just needs to be able to “fit” evenly into one of the cycles and it will be rolled-up from the one that it fits into and above. For example, a stream might have a “30 Minute” base cycle. It would receive a data value from a source device for each 30 minute interval, and that value would start rolling up to intervals such as “1 Hour,” “1 Day,” and so on up to a Year. The term “fit evenly” generally means that an integer value of cycles should fit within only one rollup cycle of greater time interval. For example, a cycle defined as “7 Seconds” will not fit evenly into a rollup cycle defined as “8 Seconds” or “1 Minutes” but will fit evenly into a cycle defined as “42 Seconds”

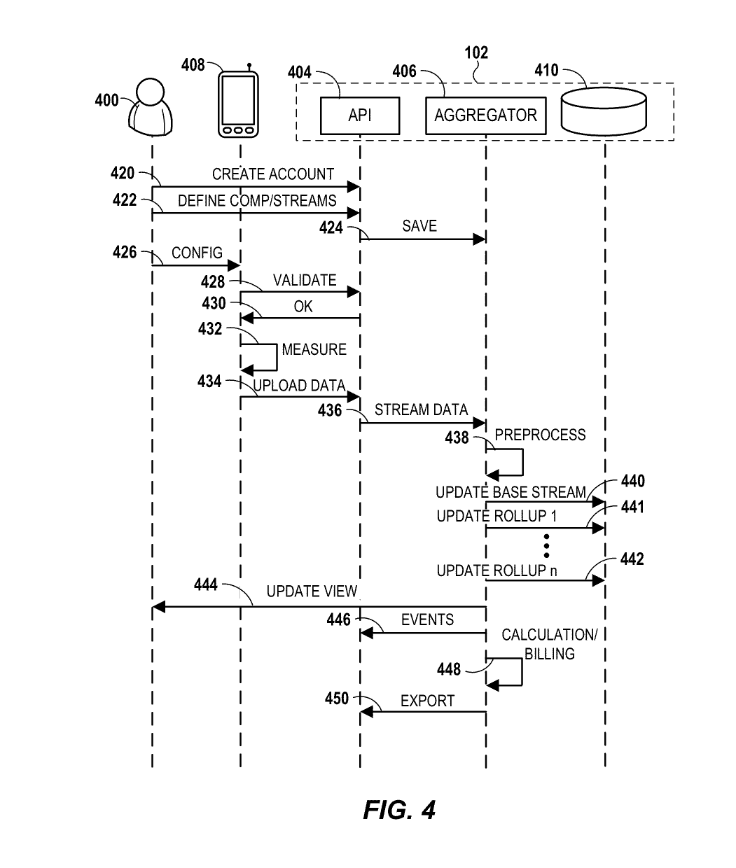

In reference now to FIG. 4, a sequence diagram illustrates a use case for using service 102 (see FIG. 2) according to an example embodiment. A user 400 logs into service 102 via API 402 and creates 420 a user account and an organization. This may involve interaction between the API 404 and an account maintenance component (not shown) to establish the account. The account enables authentication of sessions, directing of incoming data to the storage locations via aggregator component 406, regulating access to stored data, etc.

The user 400 next defines 422 a component, stream, cycles and (optionally) a rollup calendar. The user 400 creates a component with a stream that describe the attributes of a source device 408 that will be uploading data into the service 102. For example, the user 400 may define a stream as storing integer data using a ONE SECOND cycle whose intervals start on Jan. 1, 2010 12:00 am Central time zone. The user 400 then assigns (associates) the ONE SECOND cycle as the component stream's base cycle. A stream's base cycle describes the period size of the data that will be uploaded from source device 408.

In the user 400 may also create a rollup calendar that defines all additional cycles having a granularity (e.g., hours, days, months, years) larger than the base cycles. These cycles can be assigned (associated) with the source device 408 using the same stream configuration operation 422. These cycles will be validated by the system for internal compatibility, and if valid, can be assigned to the component/streams associated with source device 408.

During this stream definition process 422, the user 400 also sets other stream attributes that will direct the service's actions during a feed upload. For example, the stream's interval data type may be required (e.g., geolocation, floating point number, integer number, etc). Other optional inputs may include constraints (floor, ceiling, min, max), time filters (e.g., PM hours only), gap filling (e.g., interpolation of missing data). After the stream parameters are established, the new component is saved 424 into the system.

The user 408 will also configure 426 the device 408 to connect to the service 102 for uploading collected data. This configuration 426 may involve installation of an application, service, script, plug-in, etc., that facilitates connection to the service 102 via API 404. The data entered into the device 408 may include an address of the service 102, account information, base cycle and data type definitions. The configuration may include a validation 428, 430 that ensures the device 408 is correctly set up. The device may connect to the service and download some or all of its configuration from the service.

After the validation 428, 430, the device 408 may begin measuring 432 data and uploading 434 data as time series of data with granularity of the base interval. The stream interval data is uploaded 434 via API 404, which may utilize a RESTful protocol to facilitate uploading one or more values defined within a JavaScript Object Notation (JSON) or Extensible Markup Language (XML) string. In some arrangements, multiple components and streams can be uploaded at one time and processed in batch. The following discussion will cover examples of a single stream data upload.

The stream data 343 can arrive in different formats. For example, the data can be a collection of data objects, each having an epoch timestamp and a value produced from the measurement 432. In other arrangements, a single start date-time may be included along with a sorted list of values from the measurements 432. In the latter case, the date-time of the list of values may be derived based on the start date-time and predefined base cycle values. In this later case, it may be assumed that there are no gaps within the list of values, or that some convention is used to indicate gaps within the list.

The uploaded data 434 may be sent to aggregator component 406 for preprocessing 438 the data to conform to the base cycle definition. The aggregator 406 then stores 440 the values into a database 410, placing the values into appropriate intervals of the base stream as defined by the base cycle. The aggregator 406 also updates 441, 442 any predefined roll up streams based on the data value 436. This may also involve determined an appropriate element of the rollup streams to update based on rollup calendar definitions. This may be achieved by looking at interval start and stop date-times for each stream. In one arrangement, the interval start date-time is inclusive and the interval end date-time is exclusive, although other arrangements are possible.

The preprocessing 438 and/or updating 440-442 may also involve performing other operations on the data before storing it in the database 410. For example, optional time filter constraints may be applied. Intervals that are excluded by the time filter are set to nulls so as to minimize storage space. Other optional constraints may also be applied, e.g., minimum, maximum, floor and/or ceiling constraints. Optional gap filling algorithms may be applied to account for dealing with missing data, e.g., to intervals included by the time filter.

As previously mentioned, the user 400 may be able to view data updates as they occur, e.g., via a browser (not shown) interacting with the API 404. Therefore, in response to the upload 434 which causes updates 440-442, a view update 444 may also be sent to the user 400. This update 444 to the view may cause, for example, changes in graphical representation of the data (e.g., chart, graph, meter, numerical readout) for the base and/or all rollup streams.

Other operations may also occur in response to the upload 434. Event 446 (e.g., alert, notification) communicated externally via the API 404 may be generated as part of an event processing engine, which can trigger internal or external events in response to predefined changes in base and/or rollup streams. Other storage operations in addition to the illustrated storage events 440-442 may occur in response to the upload 434. For example, archiving, compression, removal, etc., of historical data may occur if a predetermined storage limit is reached. Internal calculation events 448 may occur in response to the upload 434, which may include events used by engines used for system health monitoring, billing, etc. Automatic exporting 450 of base and/or rollup data may also occur in response to the upload 434, such as preparation of reports in an alternate format (e.g., spreadsheet file, comma-separated variable text document, summary messages, etc.)

Updates 440-442 represent a rollup calendar being applied. Base cycle intervals are rolled-up into rollup streams. A rollup stream exists for each cycle in a rollup calendar and for each aggregation function supported by the base stream data type. Rolling up intervals is a recursive process, e.g., rollup stream 1 is updated 441 based on base stream update 440, rollup stream 2 is updated (not shown) based on rollup stream 1 update 441, etc. The technique used for one rollup cycle is applied for each rollup cycle.

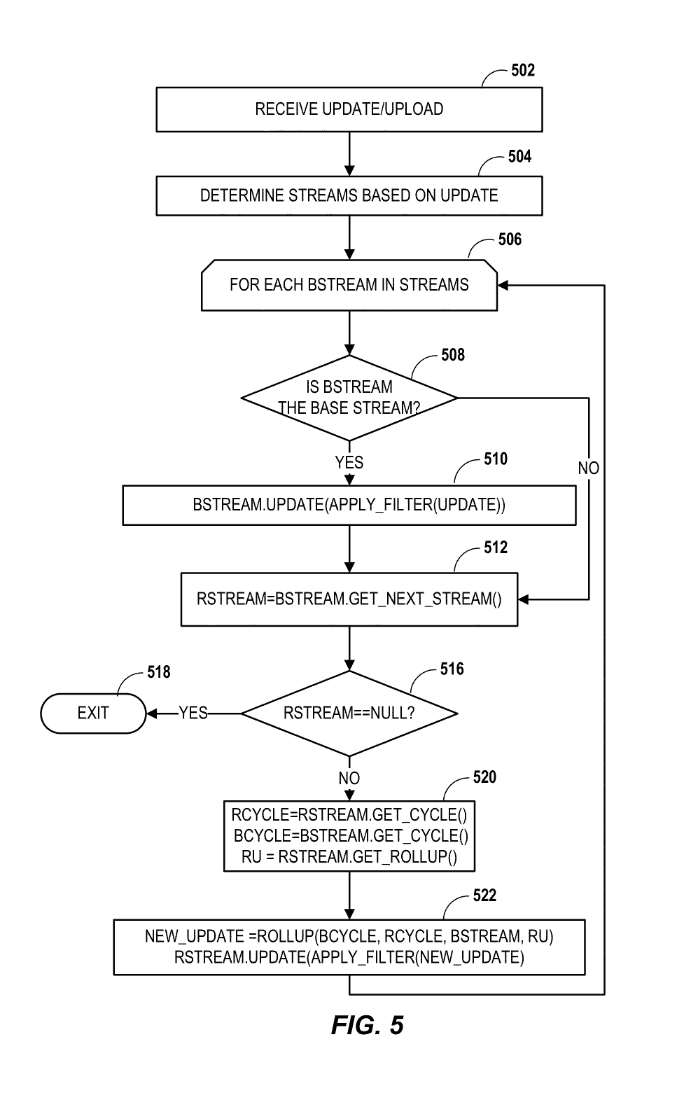

In reference now to FIG. 5, a flowchart illustrates a procedure for stream rollup according to an example embodiment. The procedure begins in response to an update 502 from a sensor device, such as upload 434 in FIG. 4. Note that the set of intervals being uploaded 502 can be one interval or thousands of intervals. A collection of streams is determined 504 from the update, e.g., from an identifier embedded in the update data, from authentication of a session in which the data was received, etc.

The system may utilize Unique Identifiers (UID) to identify 504 and access streams programmatically. Streams can be accessed with the following information: 1) ComponentUid; 2) StreamUid; 3) StreamCycleUid; and 4) RollupFunction. In arrangements where the stream UID is unique across all organizations, the componentUid can be left off or made optional. Similarly, RollupFunction and/or StreamCycleUid can be left off if the base cycle is being requested.

The collection of streams determined at block 504 may be associated with at least one component object that represents the source device. The streams should include at least the base stream, and may include rollup streams that are updated based on the base stream or on another rollup stream. The collection of streams may be in order, e.g., starting with the base stream and sorted according to cycle time size, from smallest to largest.

Block 506 represents a loop that is iterated through for each stream (bstream) in the collection of streams. At block 508, it is determined whether bstream is the base stream. In this example it may be assumed that the base stream is the first in the list of streams, and so the determination 508 may be made by looking at the position in the list. If the current stream is the base stream uploaded data for the stream 510 may be modified if the stream has a time filter and/or Floor/Ceiling/Min/Max constraints defined. For the remaining rollup streams only the next higher stream is updated, assuming such stream exists, and so operation 510 is skipped.

At block 512, the next higher stream (rstream) that is being rolled up into is found. If the current stream is the highest level stream (e.g., one with the largest cycle time granularity) the value of rstream determined at 512 will be null. As a result, the value of rstream is checked at 516, and if rstream is null, the routine exits 518. If rstream is not null, then the cycles “rcycle” and “bcycle” associated with rstream and bstream, respectively, are determined 520. The rcycle definition is used to determine the start and end date-time of each interval the base stream intervals will roll-up into. Also at block 520, a function “ru” is determined, which defines how data is rolled up into the rstream's intervals (min, max, avg, sum, etc.). At block 522, a new update is determined based on the bcycle, rcycle, bstream data, and rollup function ru. This new update is time filtered (if defined) and applied to rstream at block 522. As will be described in greater details below, rstream may include a collection of substreams each associated with a different function “ru,” in which case rollup function determination 520 and updates 522 may occur once for each substream.

Generally, to derive rollup intervals, the system retrieves any head and tail intervals for bstream from the store if they do not already exist in memory. These values may be needed to do an accurate rollup calculation. The system applies each valid rollup function (min, max, avg, sum, gap counts, etc.) to the base stream's intervals. Each function will result in a rollup stream. For example, if the base cycle is one second intervals and it rolls-up into five minute intervals then a stream will exist for each function. There may be a minimum stream, a maximum stream, an average stream and so on. Precalculating rollup streams allows for fast retrieval of these values later and will allow for real-time alert processing on rollup streams.

As noted above, optional time filter constraints may be applied during roll-up calculations. If a value's corresponding timespan is not included in the time filter then it will not impact the rollup function result. For example, the ApplyFilter function in blocks 510, 522 may return the Update or NewUpdate argument unchanged if no filter is defined. If a filter is defined, any filtered data values may be excluded from average, sum, min, max calculations and such. The filtered data may still be stored if desired even if not used in rollup calculations, although the end user may wish to discard filtered data to reduce data storage usage.

All streams can be rolled-up, but the type of data handled by the stream may determine which rollup functions are valid and can be applied. For example, a value type of STRING may not have a resulting rollup stream of min, max, avg, sum, etc., although a STRING can have rollup streams for first, last, gap count, etc. Similarly, booleans values may have special rollup logic. Dates may be treated as long integers representing milliseconds since the epoch, and geocoordinates (longitude, latitude, elevation) may be treated as doubles. These values may be rolled-up according to rules associated with the respective number types.

To enhance performance, the cycle intervals immediately below the rollup being calculated may be used to calculate a given stream's rollup value. This avoids a rollup stream with a long cycle (e.g., months, year) from having to access a large number of data values from the base cycle. For example, assume a one minute, one hour, and one day rollup calendar. The one hour stream is calculated from the one minute stream, and the one day stream is calculated from the one hour stream. This prevents the one day calculation from having to retrieve all 1440 intervals from the store. Instead, it only needs 24 intervals for its calculations. This technique allows for rolling up one second intervals over the course of long timespans, such as years or centuries, very quickly and with very few redundant values in memory. It also, allows users to update any existing base intervals and have those values rollup very quickly all within the same transaction.

Even when using proximate rollup stream data instead of the base cycle data, the system should calculate all rollup results as if only the base cycle stream intervals were used. For example, gap count streams report how many gaps occur in the base cycle. Gap counts are aggregated up the rollup calendar. If the rollup calendar is one minute, one hour, one day, each one day interval should indicate how many one min gaps there are—not how many one hour gaps there are.

Some rollup stream calculations use other rollup stream values. For example, time-weighted averages will use the previous rollup averages along with previous non-gap millisecond count streams to do the calculation. As mentioned above, the rollup engine performs rollups when intervals are appended to a base cycle to either the front or end of the stream, or intervals are changed within an existing stream. It also allows for intervals to be changed to gaps. When any of these changes occur to the base cycle stream, the rollup engine will recalculate all rollup stream intervals that are impacted and may persist them back into the store. The above algorithm makes this process fast and efficient. Uploaded base stream intervals and all impacted rollup streams are persisted to the store, all in the same transaction.

All roll-up streams can be used like other base cycle streams. They can be graphed, used for derivation calculations, imported, exported, or viewed just like any other stream. Roll-up streams are persisted to the store in the same transaction as the base cycle stream. The roll-up calculation algorithm is designed to be fast and efficient. Roll-up values are calculated whenever base cycle intervals are inserted, updated or deleted and saved in the store. Each roll-up stream is actually a set of streams, one for each roll-up calculation function (sum, min, max, avg, . . . ). This technique sacrifices storage space for rapid retrieval of roll-up values. Only the relevant existing intervals are extracted from the database prior to doing the calculation. Not all base cycle intervals need be fetched for the rollup time period being calculated. Only a set of previous rollup stream function results need to exist in memory. Since all possible rollup functions are applied at once and the results stored, those values are always available for other functions to use.

By calculating and applying all rollups functions at once, real-time data consistency can be maintained between the base stream and all of its rollup streams. For example, user requested a retrieval and calculation of rollups on a year's worth of one-second data on a currently active stream, it could take several seconds just to read the one-second data off the disc drive. In such a scenario, by the time the data is read and processed it may have been changed by new data coming in. In such a case, the rollup values might not be currently consistent with the base cycle data. Similarly, the API may allow many rollup stream results and the base cycle intervals to be queried for in one batch call. This query is done in the same transaction thus guaranteeing data consistency between the base cycle intervals and rollup intervals for the time range requested. This consistency prevent devices from doing unwanted things thereby reducing the chances of end-user confusion.

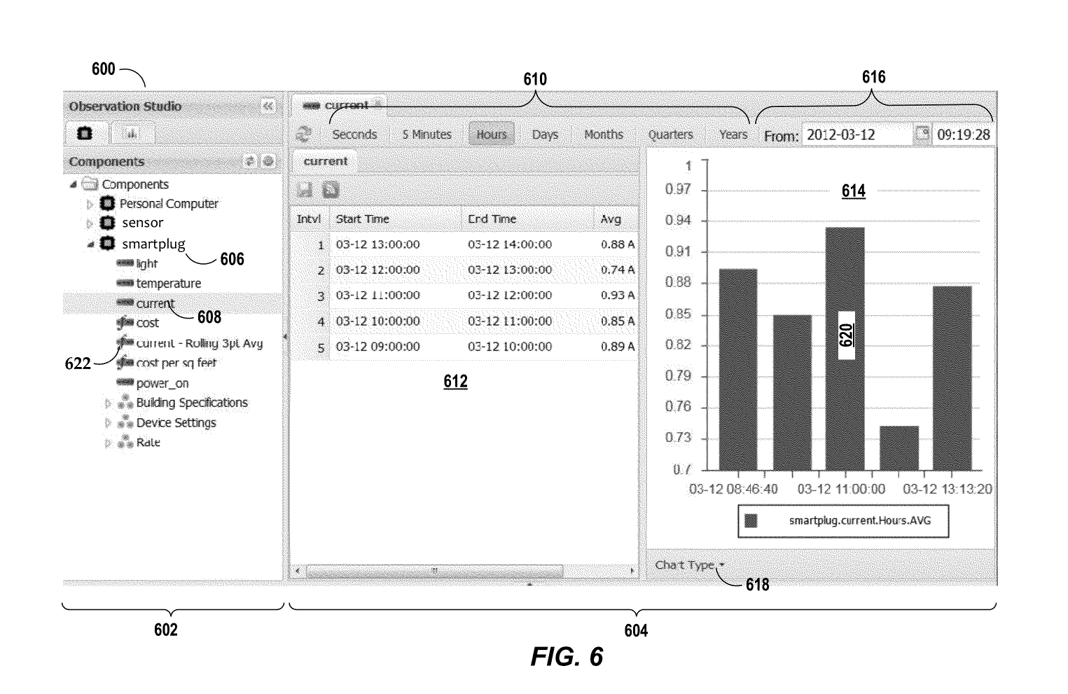

In reference now to FIG. 6, a diagram illustrates a user interface that facilitates viewing collected data according to an example embodiment. Generally, the user interface includes a screen 600 that may be displayed in a browser or implemented as a standalone, special-purpose program. The screen 600 is divided into two sections 602, 604. The left section 602 is a control selection that allows user selection of data and other content. In this view, section 602 provides a selectable hierarchy components and streams that the user has currently configured. From these components, the electrical current measurement stream 608 of a “smartplug” component 606 is selected. The measurements from the stream 608 are displayed in section 604.

In section 604, a row 610 of controls allows selecting a base or rollup stream for display based on time cycle associated with the stream. The leftmost of the controls 610 (labeled “Seconds”) selects the base stream in this example. The remaining buttons 610 select a rollup stream. The stream data is displayed in list area 612 and graph area 614. The time extents used in the display areas 612, 614 is determined via time controls 616, part of which (“To:” data and time selector) is cut off in this view. Control 618 in area 614 facilitates changing the type of graph or chart displayed (e.g., bar graph, pie chart, etc.).

The list area 612 and graph area 614 show results of a rollup function that was predefined by the user when setting up the rollup streams. The section 604 may also include a button (not shown in this view) called “Data Points,” which allows the user to select from a number of different rollup function results to display (avg, min, max, sum, gaps, . . . ). As will be described in greater detail below, the system can calculate all of these rollup functions at the same time for substreams that are part of the rollup stream. So even if the user has not previously identified the display rollup stream as displaying a particular function (e.g., avg, min, max) the user can later view this data anyway, either temporarily via the controls in section 604, or by redefining rollup stream configurations later.

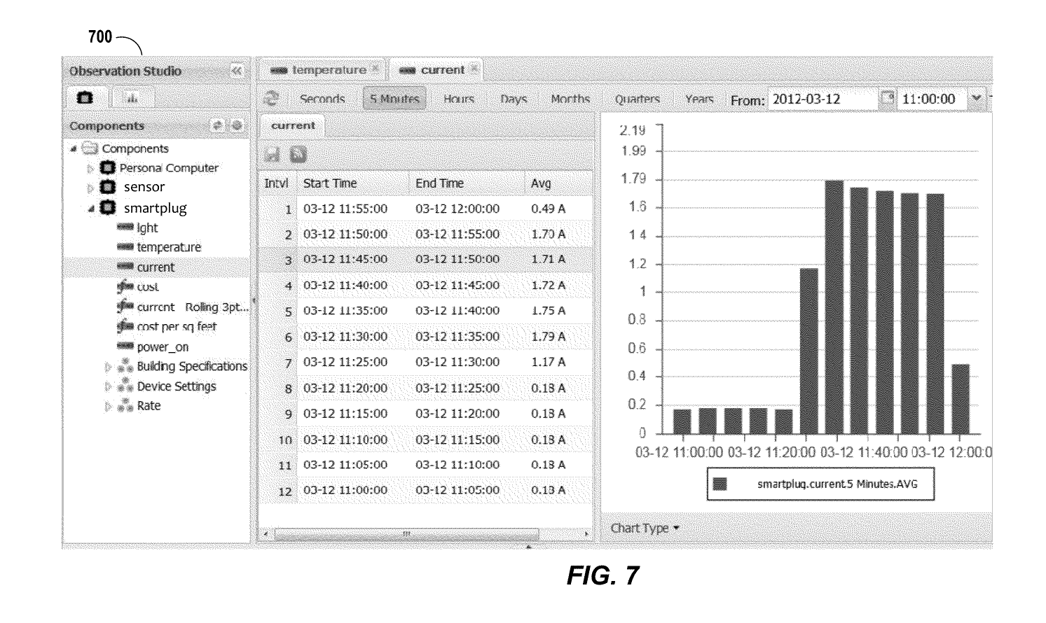

The list and graph areas 612, 614 can be implemented to support the concept of data drill-down. For example, in screen 600, the user is viewing one hour values. By selecting an element of the graph 612 (e.g., column 620), the display changes to show five-minute intervals within the selected hour, as seen in screen 700 of FIG. 7. Similarly, a drill-up may be supported, e.g., by selecting one of controls 610 in FIG. 6 that is to the right of the currently selected control 610. In such a case, a longer-cycle view is shown with time extents that encompass the currently selected element(s), e.g., element 620.

Another feature of the present embodiment is represented by user interface component 622, which represents a derived stream. Derived streams are sets of base and/or rollup streams that are derived from a user defined formula expression involving other base and/or rollup streams and/or constants. For example, the illustrated component, “cost” may have its base stream derived using a time integration of the current stream 608 multiplied by other factors (e.g., voltage, unit cost per unit energy) to derive a cumulative cost over a selected time cycle. These other factors may be constant, varied based on time (e.g., may utilize peak and non-peak energy rates), and/or may be based on other measure streams (e.g., voltage measurement). Like other streams, a derived stream can be associated with a rollup calendar and have rollup streams calculated from its derived base stream. It is like other steams except the derived stream's base cycle data isn't uploaded, but is derived periodically.

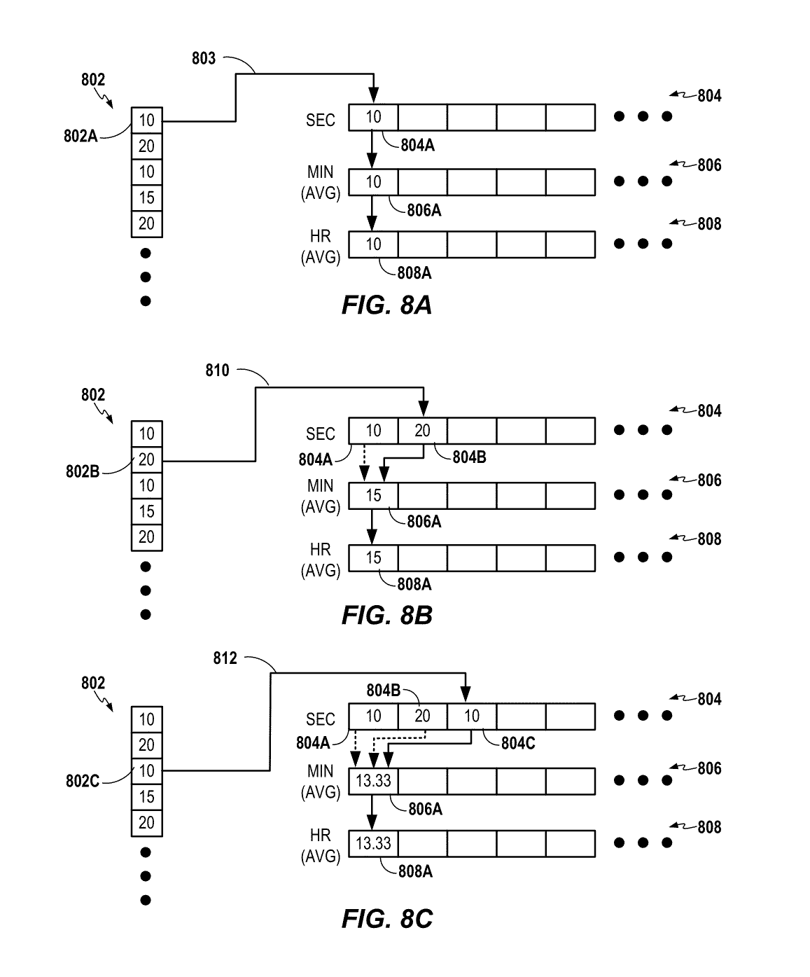

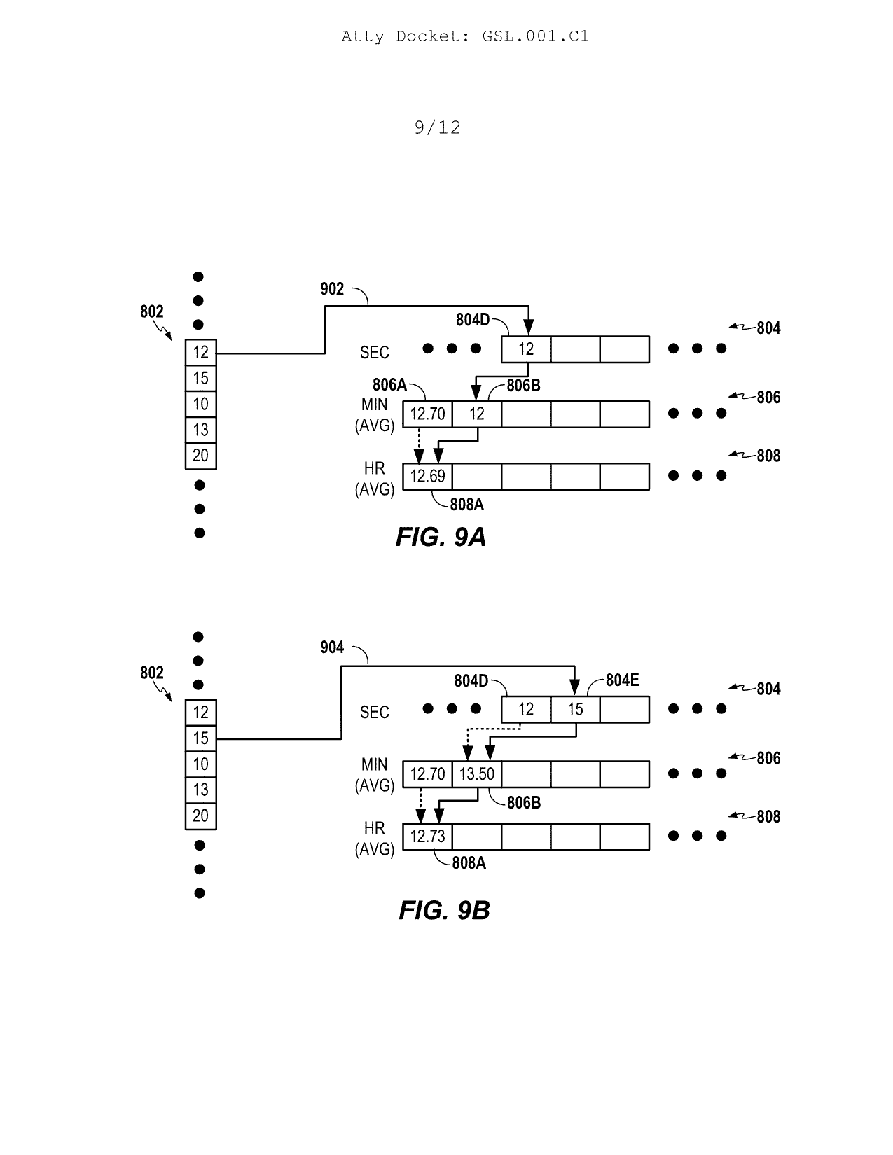

In reference now to FIGS. 8A-8C and 9A-9B, block diagrams illustrate an example of data collection and aggregation according to an example embodiment. In these diagrams, reference number 802 represents a time series of measurement data that may be received from a source device via a wide-area network. Streams 804, 806, 808 are used to store the incoming data 802. The streams 804, 806, 808 may include any combination of hardware and software that can be used to persistently store a representation of the data 802 in a data storage arrangement. For example, the streams 804, 806, 808 may be implemented as database structures (e.g., tables), each entry database storing at least date-time stamp and a data value. Or, as shown in FIG. 2, the streams 804, 806, 808 may be represented in persistent or non-persistent memory as data structures or objects (e.g., classes as shown in FIG. 3) that can be saved in other formats (e.g., files).

As the incoming data 802 arrives, the system determines any streams associated with the measurement data, including streams 804, 806, 808. For example, the streams 804, 806, and 808 may share a common identifier with data 802. Stream 804 is configured as a base stream, and has a time interval (seconds) corresponding to that of the time series of measurement data 802. Stream 806 is configured as a first rollup stream having time intervals (minutes), each element including a fixed plurality (60 in this example) of the time intervals of the base stream 804. Stream 808 is configured as a second rollup stream having time intervals (hours) each including a fixed plurality (60) of the time intervals of the first rollup stream 806.

For purposes of this example, the term “fixed” indicates that a predetermined number (60 in this example) of intervals of the base stream 804 belongs within only one interval of the rollup stream 806, and this relationship does not change over time. A similar relationship exists between streams 806 and 808. This still allows for variable size intervals so long as the inter-cycle relationship can be determined. For example, a month interval for February can be determined to contain 28 or 29 one-day intervals depending on whether the current year is a leap year or not. The system may be adaptable to support variable relationships between the streams 804, 806, such as the rollup stream 806 receiving a moving window of intervals from the base stream, the rollup stream having variable interval sizes or overlapping variables, etc. For purposes of this example, though, the relationship between intervals of streams 804, 806, and 808 is assumed to be fixed as described above.

In FIG. 8A, line 803 represents an update of least a portion of the time series of measurement data 802, in particular data element 802A. The API may support a variety of updates from the source device, including adding new data and updating or deleting existing data. Updates include a single data element or a collection of data elements from the source device. For purposes of this example, update 803 of data 802 is assumed to be added data, received one element at a time. The base streams and rollup streams 806, 808 are updated at or about the same time in response to the same update 803.

Update of the base stream 804 involves inserting the received data in element 804A. There may be filtering or limiting functions applied that modify the data or prevent it from being placed in the stream 804, but for purposes of this example each update to the base stream involves inserting the data into an element of the stream. Further, because this example is assumes incoming data 802 is time ordered with no gaps, each insertion involves appending the data to the next available element stream 804 (e.g., tail).

The update to element 804A also results in an update to elements 806A and 808A of streams 806 and 808. Each of these streams 806, 808 may be associated with an aggregator function that governs how elements from one stream are applied to another. In this example, streams 806 and 808 aggregate time-weighted averages from streams 804 and 806, respectively. This example begins assuming all streams are empty when the update 803 arrives, and so the applying the data from element 804A involves inserting the same data in both 806A and 808A, as this value corresponds to the time-weighted average of a single measurement.

In FIG. 8B, a second update event 810 involving data 802B causes an insertion of the data into element 804B of base stream 804. The interval represented by element 804B is included in both intervals of elements 806A and 808A, so the update to element 804B also results in an update to the averages in elements 806A and 808A. The update to element 806A involves obtaining at least the value of 804B, and may also implicitly or explicitly involve obtaining data from previously updated element 804A. For example, the stream 806 may also include locally maintained variables associated with element 806A, such as sum, count, gaps, non-gap time intervals, etc. These variables are associated with elements of base stream 804 that are members of 806A. As such, the update to element 806A may not require an explicit reading (represented by dashed line) from element 804A in order to update the average value.

In FIG. 8C, a third update event 812 involving data 802C causes an insertion of the data into element 804B of base stream 804, which results in an update to the averages in elements 806A and 808A. The update to element 806A involves obtaining at least the value of 804C, and may also implicitly or explicitly involve obtaining data from previously updated elements 804A and 804B. As before, the update to element 806A may not require an explicit reading (represented by dashed lines) from elements 804A and 804B in order to update the average value.

In FIG. 9A, sufficient updates have been applied so that element 806A is no longer the current element, and so update event 902 involving data 802D is now used to fill new element 806B of stream 806. As before, this represents a single value average of interval represented by 806B, which is simply the value of 804D. However, because stream 808 uses time weighted values, the updated value of element 808A is not the average of elements 806A and 806B, but is found by the formula (60*12.70+12)/61=12.69 (result is rounded to two decimal place for purposes of clarity). In other embodiments, the rollup function could be implemented as a pure average, in which case the update to element 808A would be calculated as (12.70+12)/2=12.35.

In FIG. 9B, update 904 results in updates to elements 806B and 808A as described above. The value of 806B is the average of the two elements 804D and 804E of stream 804. It should be noted that stream 806 may also keep a count of the sum and non-gap time intervals (ngti), which would have the value of sum=27 and ngti=2, respectively in FIG. 9B. These values would be passed to stream 808 instead of the average value. So element 808A would be updated as (60*12.70+sum)/(60+ngti)=(762+27)/62=12.73. This shows how stream 808 can be updated solely on corresponding values of stream 806, yet the result is the same as if stream 808 retrieved the values from base stream 804 directly.

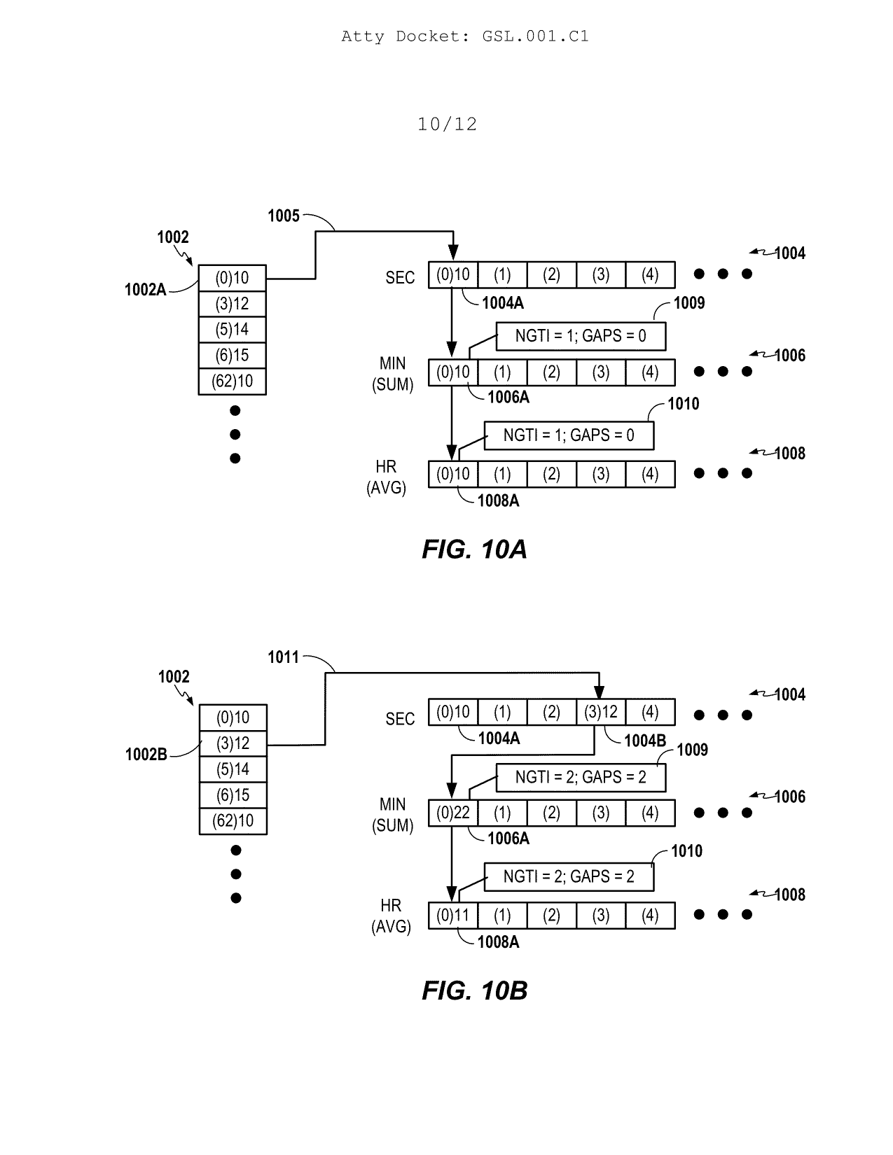

In reference now to FIGS. 10A and 10B, a block diagram illustrates an example of how gap data is handled according to an example embodiment. These diagrams show a time series of measurement data 1002 and streams 1004, 1006, 1008 similar to data 802 and streams 804, 806, and 808 in FIGS. 8A-8C and 9A-9B. One difference in this example is that minutes stream 1006 uses a sum aggregator function; hours stream 1008 uses an average aggregator function. In this example, each data element of series 1002 is assumed to be accompanied by a time stamp as indicated by parenthetical values in each block. The elements of streams 1004, 1006, 1008 also include parenthetical values of time indicated storage location for a given time value. So element 1002A received via update 1005 is placed in element 1004A due to both time stamps corresponding to t=0. This also applies to tₘᵢₙₛ=0 and tₕₒᵤᵣₛ=0 of elements 1006A and 1008A, which are updated accordingly in response to update 1005.

As indicated by blocks 1009 and 1010, elements of streams 1006 and 1008 also maintain a count of non-gap time intervals (ngti) and gaps. Because update filled the first element of intervals of both 1006A and 1008A, ngti=1 and gaps=0. In FIG. 10B, data 1002B is received via update 1011, the data having a time stamp of “3.” This is saved to location 1004B, which is non-contiguous with the previous data 1004A. As a result, the values in 1009 and 1010 are updated to ngti=2 and gaps=2. These gap and interval values can be used for purposes such as calculating rollup values. Also note that the respective sum and average values of elements 1006A and 1008A are updated appropriately.

It will be appreciated that the “gap” variables of elements 1006A and 1008A (as well as any other elements of streams 1006 and 1008) may alternately be initialized to the value of lower level intervals in each element. So, elements 1004A and 1006A would be set to gaps=60 before any data is received in base stream 1004, and the gaps value decremented for each value of ngti. In such a case, ngti+gaps=number of intervals, and so only one of these value may need to be maintained, as the quantitative relationship between intervals of the streams can be predetermined.

As seen above, a rollup stream may apply a number of rollup functions to incoming data for the benefit of subsequent rollup streams, even when the rollup stream itself does not apply/display the results of these additional functions. So even if a user-defined association between a stream defines only one aggregation function (e.g., for purposes of display, alerts, etc.), the stream may automatically calculate additional results of additional aggregation functions. The system may not be able to predict which rollup streams will be needed in the future, so the system calculates and saves the additional data. This allows retrieval of rollup information to be very fast, allowing analytics and event processing to take place in near-real-time.

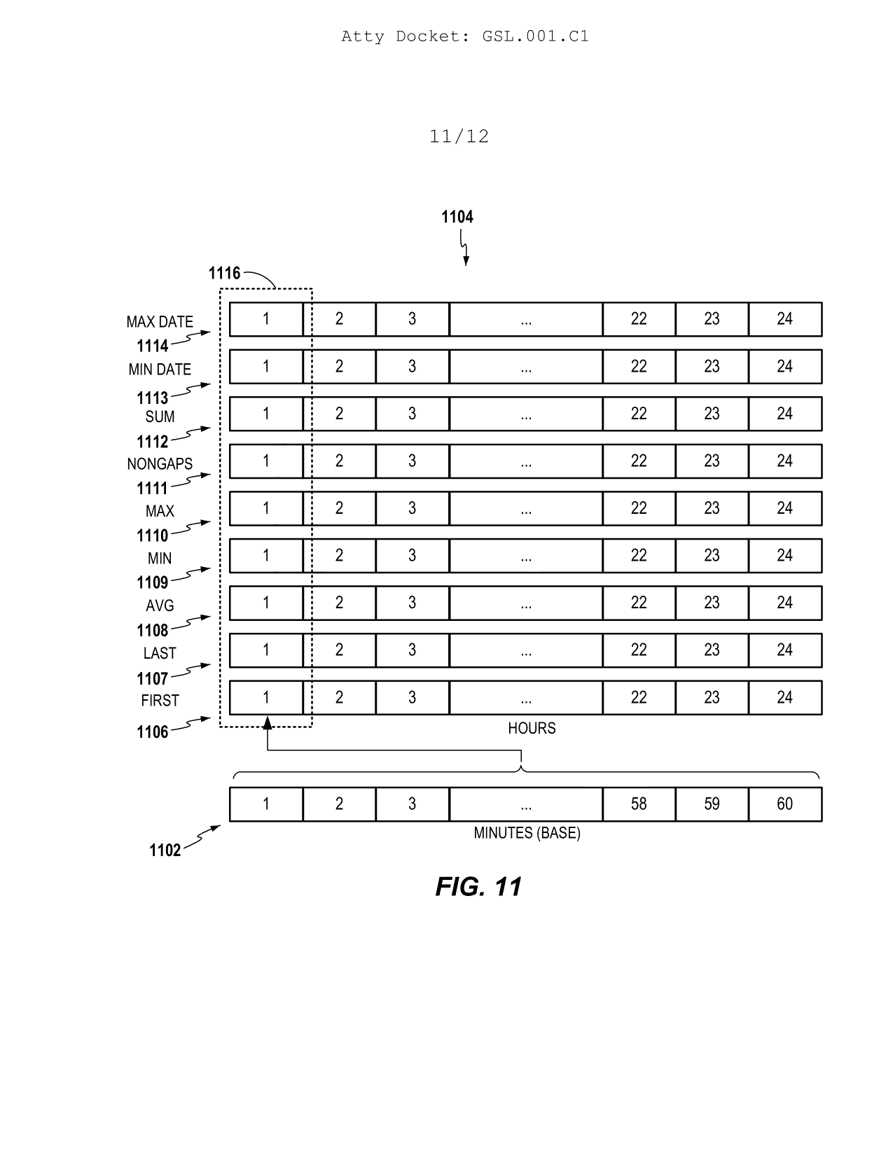

An example of how rollup streams calculate data for the benefit of other rollup streams is shown in the block diagram of FIG. 11. A base stream 1102 with cycle time of minutes is rolled up to an hours-based rollup stream, generally indicated as 1104. The rollup stream 1104 may have been defined by the user to retrieve/display stream results as a single aggregation function described herein, such as sum, min max, avg, etc. To ensure data maintained by this rollup stream 1104 can be used by subsequent rollup streams, a base set of aggregation functions is applied to all received data, regardless of whether the user has defined a rollup stream to display or otherwise use these functions. All aggregation functions may be applied even if they don't make sense from the standpoint of the end user. For example, SUM may be calculated on temperature streams even if there is little or no use from the standpoint of the user for a sum of temperature readings (although the average may still be useful). It may be possible to provide the user an option to only apply a subset of aggregation functions to rollup streams. This may allow the user to use fewer computing resources in the rollup stream, at the expense of interface simplicity and reliability (e.g., user may inadvertently remove a rollup function that causes other rollup streams to not work as intended).

As seen in FIG. 11, this may involve instantiating a rollup stream as a collection of substreams 1106-1114, each holding a series of aggregation results. The number of substreams in the collection may depend on the type of data being rolled up, e.g., some functions may not make sense for some data types. In this example data type is ‘number’ for the base and rollupstream. For number, nine example aggregation functions are defined, as represented by streams 1106-1114. A more detailed description of these functions can be found by referencing corresponding API functions in Table 1 above.

Each of nine aggregation functions (FIRST, LAST, AVG, MIN, MAX, NONGAPS, SUM, MIN DATE, MAX DATE) is associated with one of the substreams 1106-1114. When an element 1116 of the rollup stream 1104 is updated from base stream 1102, the associated elements of all substreams 1106-1114 are updated appropriately. Other data types (e.g., strings, images) may only support a subset of these functions, For example if mathematical operations such as SUM, MIN, MAX don't make sense for the data, only functions such as FIRST, LAST, NONGAPS may be allowed for that data type.

The rollup streams may be abstracted from the user as shown here so that the user is not overwhelmed, and so that the user cannot set up sequences of rollup streams where data is lost. To the user there is just one stream (the base stream) and certain aggregated methods can be applied. The user requests or references each stream with the following keys: Component+Stream+Rollup Cycle+Aggregation Function+Time Range. Thus, if a user decides to later change the Aggregation Function used by a particular stream, the system can adapt by selecting a different substream 1106-1114 (or combination thereof) without having to recalculate large amounts of data.

It will be appreciated that the list of functions in FIG. 11 is not intended to be exhaustive, and many variations are possible in view of these teachings. For example, other statistical functions such as mean, mode, standard deviation, etc., may also be used. In addition, some of the functions shown in FIG. 11 may be omitted and individual results calculated as needed. For example, the AVG value can be calculated based on a combination of SUM, MIN DATE, MAX DATE, and GAPS, as well as definition of rollup time relationship between streams 1102, 1104 (e.g., up to 60 elements of stream 1102 go into one element of stream 1104). However, a system designer may wish to strike a compromise between storage space and responsiveness by precalculating and storing a commonly used value such as AVG in order to improve user interface responsiveness, even if the value can be derived on demand from other aggregated values.

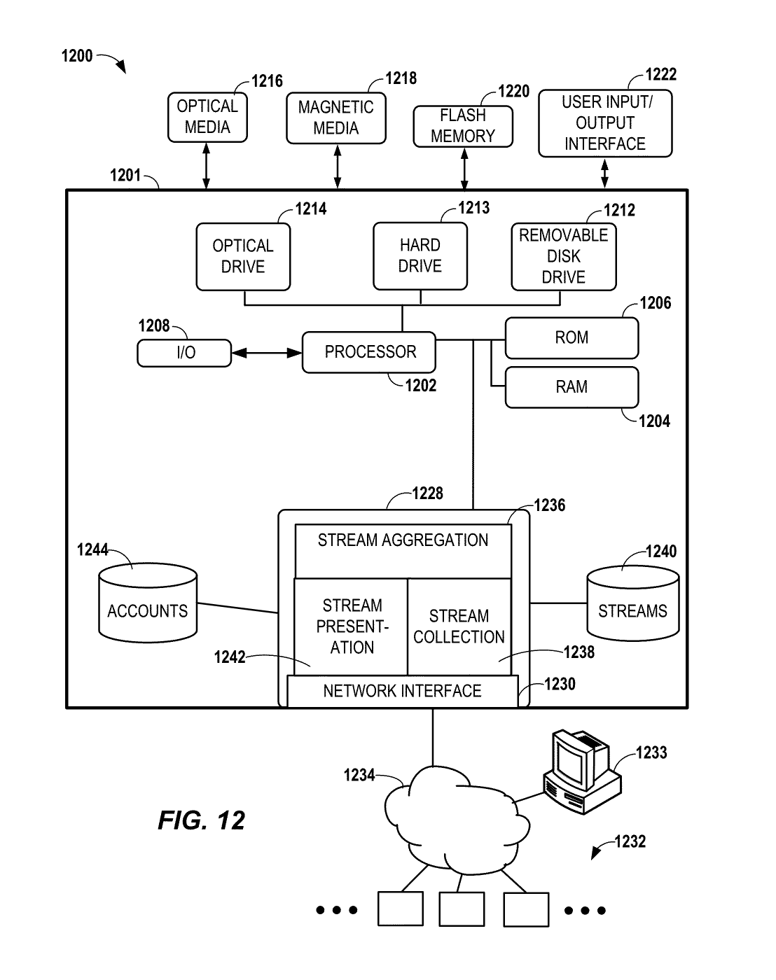

The systems and apparatuses herein may be implemented using functional circuit/software modules that interact to provide particular results. One skilled in the art can readily implement such described functionality, either at a modular level or as a whole, using knowledge generally known in the art. Generally, one or more computing structures having at least one processor coupled to memory and input/output devices can be configured via instructions to perform operations and functions described herein. A computing structure according to an example embodiment is shown in FIG. 12.

The device 1200 may be implemented via one or more conventional computing arrangements 1201. The computing arrangement 1201 may include custom or general-purpose electronic components. The computing arrangement 1201 include one or more central processors (CPU) 1202 that may be coupled to random access memory (RAM) 1204 and/or read-only memory (ROM) 1206. The ROM 1206 may include various types of storage media, such as programmable ROM (PROM), erasable PROM (EPROM), etc. The processor 1202 may communicate with other internal and external components through input/output (I/O) circuitry 1208. The processor 1202 may include one or more processing cores, and may include a combination of general-purpose and special-purpose processors that reside in independent functional modules (e.g., chipsets). The processor 1202 carries out a variety of functions as is known in the art, as dictated by fixed logic, software instructions, and/or firmware instructions.

The computing arrangement 1201 may include one or more data storage devices, including removable disk drives 1212, hard drives 1213, optical drives 1214, and other hardware capable of reading and/or storing information. In one embodiment, software for carrying out the operations in accordance with the present invention may be stored and distributed on optical media 1216, magnetic media 1218, flash memory 1220, or other form of media capable of portably storing information. These storage media may be inserted into, and read by, devices such as the optical drive 1214, the removable disk drive 1212, I/O ports 1208 etc. The software may also be transmitted to computing arrangement 1201 via data signals, such as being downloaded electronically via networks, such as the Internet. The computing arrangement 1201 may be coupled to a user input/output interface 1222 for user interaction. The user input/output interface 1222 may include apparatus such as a mouse, keyboard, microphone, speaker, touch pad, touch screen, voice-recognition system, monitor, LED display, LCD display, etc.

The device 1200 is configured with software that may be stored on any combination of memory 1204 and persistent storage (e.g., hard drive 1213). Such software may be contained in fixed logic or read-only memory 1206, or placed in read-write memory 1204 via portable computer-readable storage media and computer program products, including media such as read-only-memory magnetic disks, optical media, flash memory devices, fixed logic, read-only memory, etc. The software may also placed in memory 1206 by way of data transmission links coupled to input-output busses 1208. Such data transmission links may include wired/wireless network interfaces, Universal Serial Bus (USB) interfaces, etc.

The software generally includes instructions 1228 that cause the processor 1202 to operate with other computer hardware to provide the service functions described herein. The instructions 1228 may include a network interface 1230 that facilitates communication with source devices 1232 of a wide area network 1234. The network interface 1230 may include a combination of hardware and software components, including media access circuitry, drivers, programs, and protocol modules. The network interface 1230 may also include software modules for handling one or more network data transfer protocols, such as Hyptertext Transport Protocol (HTTP), File Transfer Protocol (FTP), Simple Mail Transport Protocol (SMTP), Short Message Service (SMS), etc.

The network interface 1230 may be a generic module that supports specific network interaction between source devices 1232 and a stream collection module 1238. The network interface 1230 and stream collection module 1238 may, individually or in combination, receive time series data measured from actual or virtual devices residing on and/or operating on source devices 1232. This data is also passed to a stream aggregation module 1236 that operates to form base and rollup streams as described herein. The stream collection module 1238 and/or aggregation module may include a database interface for storing measured and rollup data in a streams database 1240. A streams presentation module 1242 can access this data 1240 and send it out for display on a network connected user device 1233. The modules 1236, 1238, 1242 may also interact with an accounts database 1244 for purposes such as regulating user access, managing incoming stream data, cost accounting, etc.

The foregoing description of the example embodiments has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

1-20. (canceled)

21. A method, comprising:
receiving a time series of measurement data from a source device via a wide area network, the time series of measurements forming a base stream stored on a computer, the time series of measurement comprising a count of gaps of missing data;
storing on the computer a first rollup stream having a first time granularity coarser than that of the base stream, the first rollup stream comprising first data aggregated from the base stream using a first user-defined rollup function, the first rollup stream comprising a non-gap time interval count aggregated from the count of gaps of the base stream;
storing on the computer a second rollup stream having a second time granularity coarser than that of the first rollup stream, the second rollup stream comprising second data aggregated solely from the first rollup stream without reference to the base stream using a second user-defined rollup function, the aggregation utilizing the non-gap time interval count of the first user-defined rollup function; and
selectably displaying via a computer user interface a representation of at least the second rollup stream, the representation being updated in response to updates to the base stream via the source device.

22. The method of claim 21, wherein the first rollup stream comprises at least one substream comprising an additional aggregation of the base stream that is not user defined, the substream being maintained for benefit of subsequent rollup streams.

23. The method of claim 22, wherein the substream comprises the non-gap time interval count.

24. The method of claim 22, wherein the substream comprises a sum of the base stream.

25. The method of claim 21, wherein the computer user interface comprises first and second controls associated with the first and second rollup streams, the first control selectably displaying a first representation of the first rollup stream and the second control selectably displaying the representation of the second rollup stream.

26. The method of claim 21, wherein the representation is updated in near-real-time in response to updates to the base stream via the source device.

27. The method of claim 21, further comprising:
receiving a second time series of measurement data from a second source device via the wide area network, the second time series of measurements forming a second base stream stored on the computer;
storing on the computer a third rollup stream having a third time granularity coarser than that of the second base stream, the third rollup stream comprising third data aggregated from the second base stream using a third user-defined rollup function; and
forming a derived stream based on a combination of a first stream and a second stream, wherein the first stream is selected from the base stream and the first and second rollup streams, and wherein the second stream selected from the second base stream and the third rollup stream.

28. The method of claim 21, further comprising defining a time filter constraint associated with the base stream, selected measurements of the time series of measurements that are excluded by the time filter being set to null.

29. A non-transitory computer-readable medium configured with instructions, the instructions operable by a processor to perform the method of claim 21.

30. An apparatus comprising:
a network interface configured to receive a time series of measurement data from a source device via a wide-area network;
a data storage arrangement; and
at least one processor coupled to the network interface and data storage arrangement, the processor configured to:
store the time series of measurements as a base stream on the data storage arrangement, the time series of measurement comprising a count of gaps of missing data;
store on the data storage arrangement a first rollup stream having a first time granularity coarser than that of the base stream, the first rollup stream comprising first data aggregated from the base stream using a first user-defined rollup function, the first rollup stream comprising a non-gap time interval count aggregated from the count of gaps of the base stream;
store on the data storage arrangement a second rollup stream having a second time granularity coarser than that of the first rollup stream, the second rollup stream comprising second data aggregated solely from the first rollup stream without reference to the base stream using a second user-defined rollup function, the aggregation utilizing the non-gap time interval count of the first user-defined rollup function; and
cause a computer user interface to selectably display a representation of at least the second rollup stream, the representation being updated in response to updates to the base stream via the source device.

31. The apparatus of claim 30, wherein the first rollup stream comprises at least one substream comprising an additional aggregation of the base stream that is not user defined, the sub stream being maintained for benefit of subsequent rollup streams.

32. The apparatus of claim 31, wherein the substream comprises the non-gap time interval count.

33. The apparatus of claim 31, wherein the substream comprises a sum of the base stream.

34. The apparatus of claim 30, wherein the computer user interface comprises first and second controls associated with the first and second rollup streams, the first control selectably displaying a first representation of the first rollup stream and the second control selectably displaying the representation of the second rollup stream.

35. The apparatus of claim 30, wherein the representation is updated in near-real-time in response to updates to the base stream via the source device.

36. The apparatus of claim 30, wherein the processor is further configured to:
receive a second time series of measurement data from a second source device via the wide area network, the second time series of measurements forming a second base stream;
store a third rollup stream having a third time granularity coarser than that of the second base stream, the third rollup stream comprising third data aggregated from the second base stream using a third user-defined rollup function; and
form a derived stream based on a combination of a first stream and a second stream, wherein the first stream is selected from the base stream and the first and second rollup streams, and wherein the second stream selected from the second base stream and the third rollup stream.

37. The apparatus of claim 30, wherein the processor is further configured to define a time filter constraint associated with the base stream, selected measurements of the time series of measurements that are excluded by the time filter being set to null.

38. A system comprising:
a source device coupled to a wide-area network;
a cloud service comprising a computer coupled to the source device via the wide-area network and configured to:
receive a time series of measurement data from the source device, the time series of measurements forming a base stream stored on a computer, the time series of measurement comprising a count of gaps of missing data;
store on the computer a first rollup stream having a first time granularity coarser than that of the base stream, the first rollup stream comprising first data aggregated from the base stream using a first user-defined rollup function, the first rollup stream comprising a non-gap time interval count aggregated from the count of gaps of the base stream;
store on the computer a second rollup stream having a second time granularity coarser than that of the first rollup stream, the second rollup stream comprising second data aggregated solely from the first rollup stream without reference to the base stream using a second user-defined rollup function, the aggregation utilizing the non-gap time interval count of the first user-defined rollup function; and
cause a computer user interface to selectably display a representation of at least the second rollup stream, the representation being updated in response to updates to the base stream via the source device.

39. The system of claim 38, wherein the first rollup stream comprises at least one substream comprising an additional aggregation of the base stream that is not user defined, the substream being maintained for benefit of subsequent rollup streams.

40. The system of claim 38, wherein the representation is updated in near-real-time in response to updates to the base stream via the source device.
